(19) United States
(12) Patent Application Publication
(10) Pub. No.: US 2026/0005919 A1
(43) Pub. Date: Jan. 1, 2026

(54) METHOD FOR ENABLING AUTOMATED REPAIR ACTION BASED ON ALARMS

(71) Applicant: Mavenir Systems, Inc., Richardson, TX (US)

(72) Inventors: Brijesh Unnikrishnan, Bangalore (IN); Charles Santhosam Lourdu Raja, Bangalore (IN); Anitha Achar, Bangalore (IN); Liangrui Zhou, Beijing (CN)

(73) Assignee: Mavenir Systems, Inc., Richardson, TX (US)

(21) Appl. No.: 19/317,686

(22) Filed: Sep. 3, 2025

Related U.S. Application Data
(63) Continuation of application No. PCT/CN2023/079456, filed on Mar. 3, 2023.

(51) Int. Cl. H04L 41/0659; H04L 41/0668; H04L 41/0677

(52) U.S. Cl. CPC H04L 41/0661; H04L 41/0668; H04L 41/0677

(57) ABSTRACT

System and methods for automated responses to M-Plane fault management in a Radio Access Network.

### CROSS-REFERENCE TO RELATED APPLICATIONS

The present application is a continuation of International patent application PCT/CN2023/079456, filed Mar. 3, 2023 and is incorporated herein by reference in entirety.

### BACKGROUND OF THE DISCLOSURE

### a. Field of the Disclosure

The present disclosure relates to Radio Access Networks and Cloud Radio Access Networks. The present disclosure focuses on the design of operation, administration and management of various network elements of 4G and 5G based mobile networks.

### a. Description of the Related Art

Open-Radio Access Network (O-RAN) Alliance is a group that defines the specification for the next generation RAN solutions comprising of the interface between the various RAN components such as O-RAN DU, O-RAN CU, and O-RAN RU based on lower layer split (LLS).

Virtualized RAN (vRAN) and Cloud RAN refers to an implementation of the RAN which virtualizes network functions in software platforms based on general purpose processors and moving some of the components to a cloud server.

Conventional RANs were built employing an integrated unit where the entire RAN was processed. Conventional RANs implement the protocol stack (e.g., Physical Layer (PHY), Media Access Control (MAC), Radio Link Control (RLC), Packet Data Convergence Control (PDCP) layers) at the base station (also referred to as the evolved node B (eNodeB or eNB) for 4G LTE or next generation node B (gNodeB or gNB) for 5G NR). In addition, conventional RANs use application specific hardware for processing, which make the conventional RANs difficult to upgrade and evolve.

Cloud-based Radio Access Networks (CRANs) are networks where a significant portion of the RAN layer processing is performed at a baseband unit (BBU), located in the cloud on commercial off the shelf servers, while the radio frequency (RF) and real-time critical functions can be processed in the remote radio unit (RRU), also referred to as the radio unit (RU). Both CUs and DUs are also known as baseband units (BBUs). The BBU can be split into two parts: centralized unit (CU) and distributed unit (DU). CUs are usually located in the cloud on commercial off the shelf servers, while DUs can be distributed. The BBU may also be virtualized, in which case it is also known as vBBU. Radio Frequency (RF) interface and real-time critical functions can be processed in the remote radio unit (RRU).

For the RRU and DU to communicate, an interface called the fronthaul is provided. 3rd Generation Partnership Project (3GPP) has defined 8 options for the split between the BBU and the RRU among different layers of the protocol stack. There are multiple factors affecting the selection of the fronthaul split option such as bandwidth, latency, implementation cost, virtualization benefits, complexity of the fronthaul interface, expansion flexibility, computing power, and memory requirement.

One of the most common splits that are standardized recently by O-RAN alliance is split option 7-2x (Intra-PHY split). This split has multiple advantages such as simplicity, transport bandwidth scalability, beamforming support, interoperability, support for advanced receivers and inter-cell coordination, lower O-RU complexity, future proof-ness, interface and functions symmetry.

Traditionally, the radio access networks were built as an integrated unit where the entire RAN was processed. The RAN network traditionally uses application specific hardware for processing, making it difficult to upgrade and evolve. As future networks evolve to have massive densification of networks to support increased capacity requirements, there is a growing need to reduce the capital expense costs and operating expense costs of RAN deployment and make the solution scalable and easy to upgrade.

The Management Plane, or M-plane, refers to non-real-time management operations between the O-DU and the O-RU. Specifically, The Lower-Layer Split M-plane (LLS-M) facilitates the initialization, configuration, and management of the O-RU to support the stated functional split. The M-plane, specifies the management plane protocols used over the fronthaul interface linking the O-RU with other management plane entities, which can include the O-DU, the O-RAN defined Service Management and Orchestration (SMO) functionality as well as other Network Management Systems.

A NETCONF/YANG-based M-Plane is used for supporting the management features, including “startup” installation, software management, configuration management, performance management, fault management, and file management towards the O-RU. The M-Plane provides the major functionalities to the O-RU. These features are implemented using the NETCONF provided functions such as “Startup” installation, SW management, Configuration management, Performance management, Fault Management, and File Management. The data models representing the M-Plane are organized as a set of reusable YANG modules.

A feature of the standard maintained by the ORAN Alliance is the possible use of inter-vendor systems. For example, an O-DU of a particular vendor can inter operate with O-RUs of multiple vendors. Fault management is an important aspect for any inter vendor integrations. Currently most of the standards, including the ORAN Management Plane standard, has adopted the principles of YANG models defined in RFC-8632 to define the fault management YANG model.

Conventional systems rely on manual recovery procedures based on a text string that comes in “proposed-repair-actions” field. Manual recovery is implemented in conjunction with an alarm dictionary, which had detailed descriptions of the alarms, probable causes and recovery actions. This alarm dictionary can become unmanageable when the number of inter-vendor integrations goes up.

Existing alarm fields are configured to indicate a fault-id. However, in a multi-vendor deployment, the same fault-id can be used by multiple vendors. Accordingly, multiple alarm mapping dictionaries have to be maintained on a per-vendor basis to distinguish the faults coming from various sources.

FIG. 1 shows a logical flow for a conventional fault recovery with a text-string based proposed-repair-actions field. At block 102, a first NETCONF server (NETCONF Server 1) detects a fault condition. At block 104, the NETCONF server 1 generates an alarm message for the fault (“ABC”) with a fault-id and proposed repair action. The NETCONF server 1 sends the notification message to the NETCONF client, and at block 106, the NETCONF client maps the fault-id=1 to a fault name (for example “Alarm_ABC”) based on an internal mapping table, which can be displayed by the management system. Then, at block 108 another NETCONF server (NETCONF Server 2) from a different vendor also detects a fault condition. At block 110, NETCONF server 2 also generates an alarm message for the fault (“XYZ”) with a fault-id and the proposed repair actions field. The NETCONF server sends the notification message to the NETCONF client, and at block 112, the NETCONF client maps the fault-id=1 to a fault name (for example “Alarm_XYZ”) based on an internal mapping table, which again can be displayed by the management system.

A disadvantage of this conventional fault notification is that, as noted above, the “proposed-repair-actions” parameter is defined as string, which means that the value can accept any free text. This makes it very difficult for the client recipient of this alarm to make any automated repair action. Even if automated recovery mechanisms were to be implemented, the recovery mechanism would require offline handshaking between the vendors on the exact string to be used.

This also prevents plug and play deployments (for e.g.: between O-RU and O-DU/Service Management and Orchestration (SMO)) without offline handshake between vendors. Any deployments would have to have vendor specific development at each Network Functions (NFs) to handle proprietary alarms.

### SUMMARY OF THE DISCLOSURE

Described in the present disclosure are implementations for enabling an efficient method for performing alarm management by providing a mechanism for auto recovery actions of network elements based on an alarm raised for a fault condition.

Also described is a fault name along with a fault id for all the faults reported by network elements. This can facilitate the usage of same fault ids by multiple vendors in a multi-vendor deployment.

In an implementation, an automated proposed repair field (“auto-proposed-repair-actions”) can be implemented so that a client recipient for alarms can autonomously do any recovery action wherever possible.

In addition, in an implementation a target object field (“target-object”) can be added to indicate the object on which the proposed repair action shall be carried out.

Based on the above-referenced parameters, the recipient of the alarm can perform automatic recovery procedures. Manual intervention is thereby reduced, resulting in faster and more seamless fault recovery.

In an implementation, multiple recovery actions can be defined for each fault reported. A client can be configured to auto-trigger each of these recovery actions till the fault is rectified. If the auto recovery actions were not successful, after attempting each of the defined recovery actions in the auto-proposed-repair-actions field, a manual recovery action can then be triggered.

In an implementation, notifications are configured to include a fault-name field, which the network function can use “as is” without the need for mapping of fault-ids to alarm name.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified. For a better understanding, reference can be made to the following Detailed Description, which is to be read in association with the accompanying drawings.

FIG. 1 shows a logical flow for a conventional fault recovery.

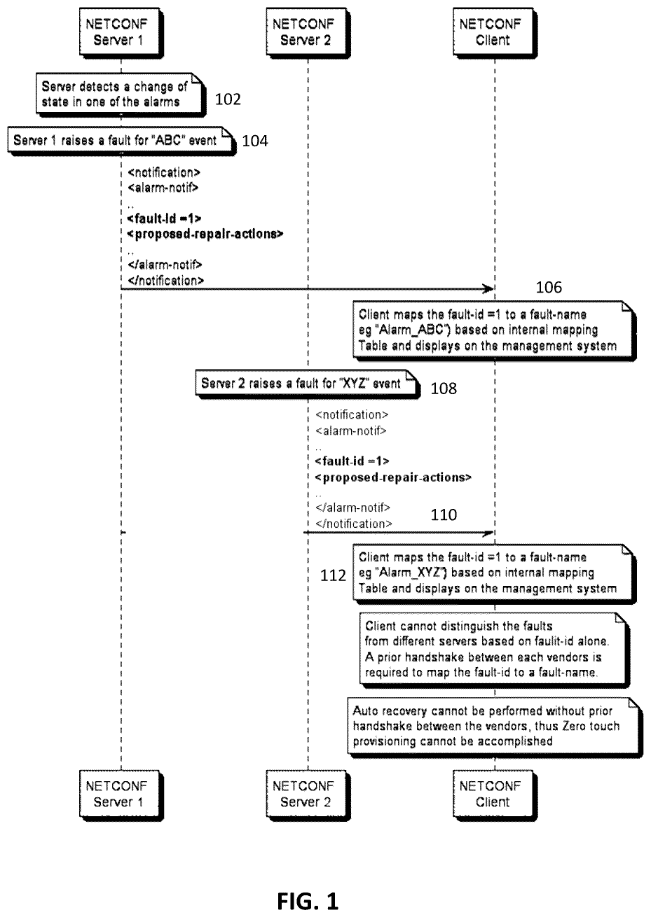

FIG. 2A shows a logical flow for an exemplary alarm management operation.

FIG. 2B shows another logical flow for an exemplary alarm management operation.

### DETAILED DESCRIPTION OF THE EMBODIMENTS

Various embodiments and implementations now will be described more fully hereinafter with reference to the accompanying drawings, which form a part hereof, and which show, by way of illustration, specific embodiments by which the innovations described herein can be practiced. The embodiments can, however, be embodied in many different forms and should not be construed as limited to the embodiments and implementations set forth herein; rather, these embodiments and implementations are provided so that this disclosure will be thorough and complete, and will fully convey the scope of the embodiments and implementations to those skilled in the art. Among other things, the various embodiments and implementations can be methods, systems, media, or devices. The following detailed description is, therefore, not to be taken in a limiting sense.

Throughout the specification and claims, the following terms take the meanings explicitly associated herein, unless the context clearly dictates otherwise. The term “herein” refers to the specification, claims, and drawings associated with the current application.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Reference is made to Third Generation Partnership Project (3GPP), Open-Radio Access Network (O-RAN), and the Internet Engineering Task Force (IETF) in accordance with embodiments of the present disclosure. The present disclosure employs abbreviations, terms and technology defined in accord with Third Generation Partnership Project (3GPP) and/or Internet Engineering Task Force (IETF) technology standards and papers, including the following standards and definitions. 3GPP and IETF technical specifications (TS), standards (including proposed standards), technical reports (TR) and other papers are incorporated by reference in their entirety hereby, define the related terms and architecture reference models that follow.
[1] RFC 8632 Internet Engineering Task Force (IETF) Request, Request for Comments: 8632, A YANG Data Model for Alarm Management, September 2019
[2] O-RAN Management Plane Specification, O-RAN.WG4.MP.0-v10.00,

### Abbreviations

RU—Radio Unit
PHY—Physical Layer
LLS-M—the Lower-Layer Split M-plane
eNB—Evolved NodeB
MAC—Medium Access Control
CU—Centralized Unit
DU—Distributed Unit
gNB—Next generation nodeB
3GPP—3rd Generation Partnership Project
vRAN—Virtualized RAN
O-RAN Open-Radio Access Network
SMO—Service Management and Orchestration
M-Plane—Management Plane

### Auto Repair Action

Described are implementations of a parameter for auto-proposed-repair-actions as an enumeration. An auto-proposed-repair action field is configured to clearly define the action to be taken on the alarm to auto recover from the fault scenario. An additional parameter can be added to indicate the object on which the repair action has to be performed.

RFC 8632 and the ORAN Management Plane Specification includes a parameter for a proposed recovery action. However, the proposed recovery is defined as a string, and thus can have any free text. In a conventional system, for any auto recovery action to be implemented, a prior handshake needs to be agreed upon between vendors which matches the string to the actual actions. As the number of vendors, increases, the complexity goes multifold. Absence of the handshake would mean that any recovery must be manual.

Accordingly, as described herein, the system can be configured with specific predefined values for the auto-proposed-repair-actions field and target-object field, thereby ensuring that the client can take an appropriate action on a specified object autonomously.

In an implementation, an automated proposed repair field (“auto-proposed-repair-actions”) can be implemented in an RFC 8632 and ORAN M-plane specification as an enumeration so that a recipient for alarms can autonomously do any recovery action wherever possible. Values for this enumeration can include, for example: NONE, RESET, DEACTIVATE, REACTIVATE, CALIBRATE, DELETE, RECREATE.

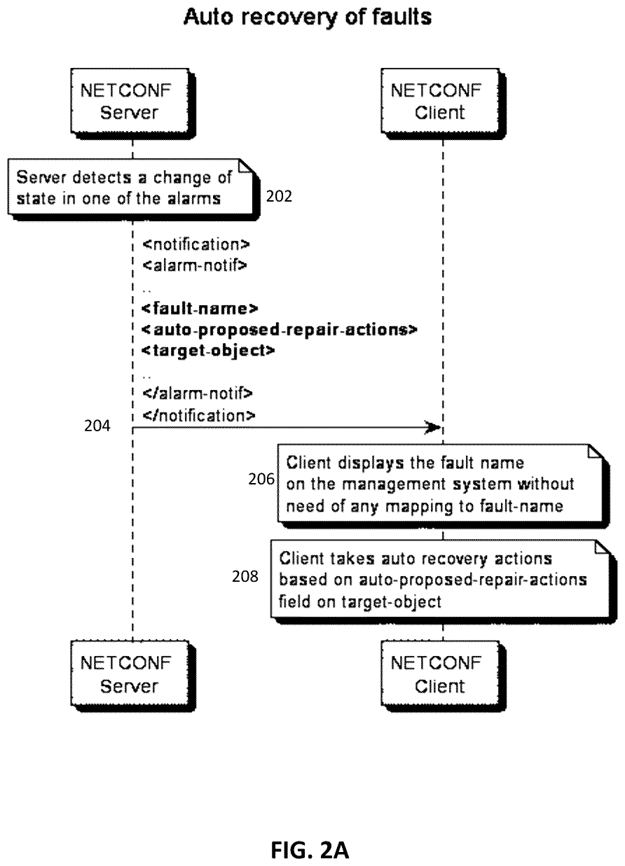

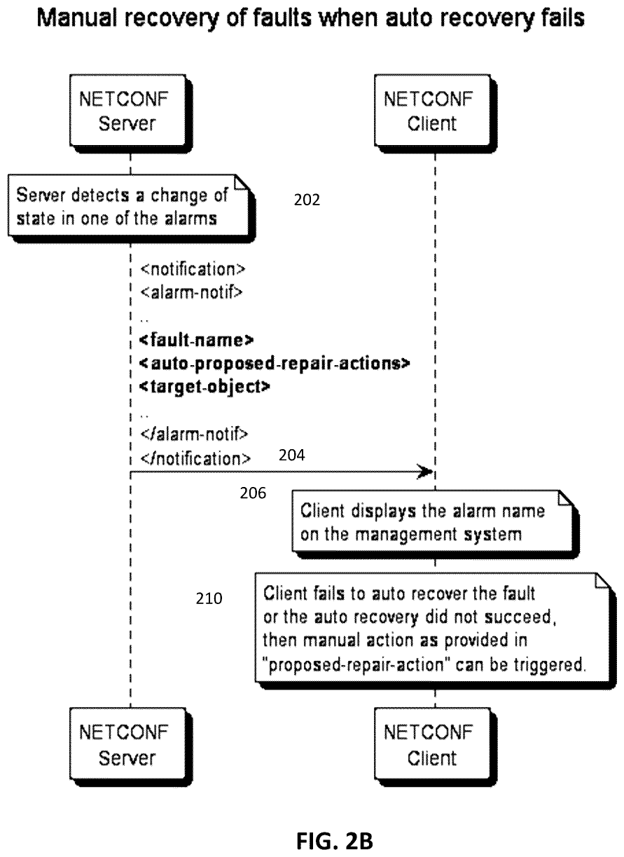

As shown in FIG. 2A in an implementation, multiple recovery actions can be defined for each fault reported. A client can be configured to trigger each of these recovery actions until the fault is rectified.

FIG. 2A shows a logical flow for an exemplary alarm management operation. At block 202, a NETCONF server, detects a fault condition. At block 204, the server generates an alarm message for the fault, including apart from other fields, a fault name, an auto-proposed-repair-actions field, and target-object field. At block 206, a NETCONF client receives the alarm without any need to map to a fault name. At block 208, the client takes the appropriate actions based on the actions specified in the auto-proposed-repair-actions.

As shown in FIG. 2B, in a case where the auto recovery actions are not successful, at block 210, a manual procedure can be triggered to rectify the fault condition. As shown in FIG. 2B, if the auto recovery actions were not successful after attempting each of the defined recovery actions in the auto-proposed-repair-actions field, then manual recovery action could be triggered.

For example, an alarm can be raised with auto-proposed-repair-actions “reactivate”, a target-object as “tx-array-carrier1”, and with auto-proposed-repair-actions “recreate”, and with the target-object as “tx-array-carrier1”. The client recipient, based on the message can autonomously reactivate the particular tx-array-carrier to revive the fault scenario. In case this reactivation fails, the recipient can try the next option, which is “recreate” of the particular tx-array-carrier. Thus, manual intervention is eliminated in this case.

In addition, in an implementation a target object field (“target-object”) can be added to indicate the object on which the proposed repair action shall be carried out. The target object field parameter can be defined as a string, which can include a reference to one of the existing objects defined. For example, the reference can point to objects defined in hardware YANG or the user plane YANG.

Based on the above-referenced parameters, the recipient of the alarm can perform automatic recovery procedures. Manual intervention is thereby reduced, resulting in faster and more seamless fault recovery.

In an implementation, multiple recovery actions can be defined for each fault reported. A client can be configured to auto-trigger each of these recovery actions till the fault is rectified. If the auto recovery actions were not successful, after attempting each of the defined recovery actions in the auto-proposed-repair-actions field, a manual recovery action can then be triggered.

In an implementation, auto-proposed-repair-actions can be listed and configured to trigger in an order of actions for the NETCONF client starting from actions having the least impacts to the system. For example, a set of auto-proposed-repair-actions that execute from least to most impact on the system can include 1. reactivate Tx-array-carrier1, 2. recreate Tx-array-carrier, and then 3. Reset Radio (RU).

In an implementation, if both proposed-repair-actions and auto-proposed-repair-actions fields are present, then the system can be configured so that auto recovery procedures take precedence over manual recovery processes. Manual recovery can be triggered in scenarios where the fault is not rectified based on auto recovery actions.

### Fault Name

RFC 8632 and the ORAN Management Plane specification also provides the mechanism to report alarms based on fault-id. In a multi-vendor deployment, an internal dictionary has to be maintained which maps each fault id to a fault name for each vendor. This fault name will be displayed at the management system. As the number of vendors increase, the number of entries in the dictionary or the number of dictionaries to be maintained increases as well. In conventional systems, this could become unmanageable and is prone to errors. This approach also further hampers plug and play operations.

Accordingly, in an implementation, system is configured to include a fault-name field, which the network function can use “as is” without the need for mapping of fault-ids to an alarm name. Introduction of the fault-name field allows multiple vendors to use overlapping fault ids and thus does not necessitate a prior handshake between vendors. As the fault name of alarm is included, the same can be fed into management system without the need for any mapping. Thus, the processing of alarms is more transparent and easier to manage for each vendor. Thus the system can be configured with predetermined fault ids for the fault name field such as, for example, Vendor 1: Fault ID 1: Fault name: High temperature; Vendor 2: Fault ID 1: Fault name: System overload; and so on.

### Example

An exemplary alarm notification format for an ORAN M-plane is as shown below. As disclosed above and emphasized below, the notification includes a fault name field, and for auto recovery, field for auto-repair target-object and auto-proposed-repair-actions.
notifications:
   +---n alarm-notif
   +--ro fault-id uint16
   +--ro fault-name? string
   -ro fault-source string
   +--ro affected-objects*[ ]
         |+--ro name string
   +--ro fault-severity enumeration
   +--ro is-cleared boolean
   +--ro fault-text? string
   +--ro probable-cause? string
   +--ro specific-problem? string
   +--ro proposed-repair-actions? string
   +--ro auto-repair-actions*[target-object]
      +--ro target-object? string
      +--ro auto-proposed-repair-actions*enumeration
   +--ro event-time yang: date-and-time
   +--ro alarm-type? enumeration

It will be understood that implementations and embodiments can be implemented by computer program instructions. These program instructions can be provided to a processor to produce a machine, such that the instructions, which execute on the processor, create means for implementing the actions specified herein. The computer program instructions can be executed by a processor to cause a series of operational steps to be performed by the processor to produce a computer-implemented process such that the instructions, which execute on the processor to provide steps for implementing the actions specified. Moreover, some of the steps can also be performed across more than one processor, such as might arise in a multi-processor computer system or even a group of multiple computer systems. In addition, one or more blocks or combinations of blocks in the flowchart illustration can also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. The foregoing examples should not be construed as limiting and/or exhaustive, but rather, an illustrative use case to show an implementation of at least one of the various embodiments.

1. A method for a M-plane fault management interface in a radio access network system comprising:
a NETCONF server;
a NETCONF client;
the method comprising;
detecting a fault condition by the NETCONF server;
generating, by the NETCONF server, an alarm message comprising an auto-proposed repair action field;
sending the alarm message to the NETCONF client;
executing, by the NETCONF client, the action in the auto-proposed-repair-action field.

2. The method of claim 1 wherein the NETCONF client is configured to trigger a manual recovery procedure if the action in the auto-proposed-repair-action field is unsuccessful.

3. The method of claim 1, wherein the auto-proposed-repair-action field is configured with predefined values.

4. The method of claim 1, wherein the alarm message further comprises a target object field.

5. The method of claim 4, wherein the target object field is configured with predefined values.

6. The method of claim 1, the method further comprising
generating the alarm notification, by the NETCONF server, comprising a plurality of auto-proposed-repair-actions for the fault condition; and
executing, by the NETCONF client; one or more of the plurality of auto-proposed-repair-actions until the fault condition is repaired.

7. The method of claim 6, wherein the NETCONF client is configured to trigger a manual recovery if each of the plurality of the auto-proposed-repair-actions are unsuccessful.

8. The method of claim 4, wherein the auto-proposed-repair-actions are executed in a sequence from actions have the least impact on the system to impacts having a greater impact on the system.

9. The method of claim 1 wherein the fault message comprises:
a proposed-repair-action field and the auto-proposed-action-field, and the system is configured to execute one or more of the actions in the auto-proposed-action-field before triggering a recovery procedure in the proposed-repair-action field.

10. The method of claim 1 wherein the message includes a fault-name field, the fault-name field being configured to allow multiple vendors to use overlapping fault identifications.

11. A system for a M-plane fault management interface in a radio access network system comprising:
a NETCONF server configured to execute the method comprising:
detecting a fault condition;
generate an alarm message comprising an auto-proposed repair action field; and
send the alarm message to a NETCONF client configured to execute the action in the auto-proposed-repair-action field.

12. The system of claim 11 wherein the NETCONF client is configured to trigger a manual recovery procedure if the action in the auto-proposed-repair-action field is unsuccessful.

13. The system of claim 11, wherein the auto-proposed-repair-action field is configured with predefined values.

14. The system of claim 11, wherein the alarm message further comprises a target object field.

15. The system of claim 14, wherein the target object field is configured with predefined values.

16. The system of claim 11, wherein the NETCONF server is configured to generate the alarm notification comprising a plurality of auto-proposed-repair-actions for the fault condition; and
the NETCONF client is configured to execute one or more of the plurality of auto-proposed-repair-actions until the fault condition is repaired.

17. The system of claim 16, wherein the NETCONF client is configured to trigger a manual recovery if each of the plurality of the auto-proposed-repair-actions are unsuccessful.

18. The system of claim 17, wherein the auto-proposed-repair-actions are executed in a sequence from actions have the least impact on the system to impacts having a greater impact on the system.

19. The system of claim 11 wherein the fault message comprises:
a proposed-repair-action field and the auto-proposed-action-field, and the system is configured to execute one or more of the actions in the auto-proposed-action-field before triggering a recovery procedure in the proposed-repair-action field.

20. The system of claim 11 wherein the message includes a fault-name field, the fault-name field being configured to allow multiple vendors to use overlapping fault identifications.
